(19) United States
(12) Patent Application Publication
(10) Pub. No.: US 2005/0030429 A1
(43) Pub. Date: Feb. 10, 2005

(54) Correction of the scan speed of a display screen

(75) Inventors: Jean-Marie Paladel, Tullins (FR); Benoit MarChand, Grenoble (FR); Benoit Van-Landeghem, Noyarey (FR)

Correspondence Address: James H. Morris;Wolf, Greenfield & Sacks, P.C., 600 Atlantic Avenue, Boston, MA, 02210-2206, US

(73) Assignee: STMicroelectronics S.A., Montrouge (FR)

(21) Appl. No.: 10/913,108

(22) Filed: Aug. 6, 2004

(30) Foreign Application Priority Data
Aug. 8, 2003 (FR) 03/50415

(51) Int. Cl. H04N 5/21

(52) U.S. Cl. 348/626

(57) ABSTRACT

A method and a device for correcting the line scan speed of a display screen according to the luminance of the pixels displayed on screen, wherein the line scan speed is modified with a correction means controlled from a control signal varying like the product of the first and second derivatives of the luminance signal.

### BACKGROUND OF THE INVENTION

1. Field of the Invention

The present invention relates to a device and a method for correcting the scan speed of a display screen.

Generally, a video image is displayed on the display screen of a display terminal by exciting phosphors arranged on the screen by means of one or several electron beams, emitted by electron guns. In the case of a color screen, a cathode-ray tube with three electron beams, which each excite a phosphor type respectively emitting a red, green, or blue light, is generally used. The electron beams are modulated in intensity from modulations signals representative of the image to be displayed on screen.

2. Discussion of the Related Art

Generally, the electron beams are focused at a point of the screen and are deviated together to scan screen lines. The electron beams scan the screen lines from the left to the right of the screen, returning to the left of the screen after scanning of each line. The screen scanning is performed from the upper horizontal edge to the lower horizontal edge.

The electron beam deviations are obtained by two main deflection coils, one main horizontal deflection coil that controls the scanning of each screen line or horizontal scanning, and one main vertical deflection coil that controls the electron beam deviations in the vertical direction.

Electron beam modulation signals generally are low-voltage signals and must be amplified by a power amplifier before being transmitted to the electron guns. To reduce the cost of the display terminal, the power amplifier generally is a low-cost power amplifier with a limited passband. This imposes a maximum variation speed of the modulation signal. For example, for a black and white display, a wider or narrower grey shading region is obtained upon transition between white and black regions. Now, it is generally desirable for the displayed image to have a great sharpness, that is, for transitions between regions associated with low and high-level modulation signals to be clean. As an example, this corresponds for an image displayed in black and white to clean transitions between black and white regions.

To improve the clearness of the displayed images, it is known to correct the horizontal scan speed.

FIG. 1 schematically shows a display terminal 10 comprising a conventional horizontal scan speed correction circuit. Display terminal 10 comprises a video processing unit 12 (VIDEO PROCESSOR) which receives a composite video signal V_{C}. After a conventional processing of composite video signal V_{C}, video processor 12 provides, in the case of a color display screen, three low-voltage modulation signals R₀, G₀, B₀ respectively associated with the red, green, and blue colors. Modulation signals R₀, G₀, B₀ are amplified by a power amplifier 13 which provides three amplified high-voltage modulation signals R, G, B. Each amplified modulation signal R, G, B is provided to an electron gun 14A, 14B, 14C of a display screen 15 generating an electron beam, the intensity of which depends on the intensity of the associated amplified modulation signal R, G, B.

The correction circuit comprises a control and amplification circuit 16 receiving low-voltage modulation signals R₀, G₀, B₀ and provides a control signal S_{C} to an additional horizontal deflection coil 17. Additional horizontal deflection coil 17 modifies the horizontal scan speed imposed by the main horizontal deflection coil (not shown).

FIG. 2A schematically shows an example of the forming of control and amplification circuit 16 comprising an adder 18 (Σ) receiving low-voltage modulation signals R₀, G₀, B₀ and providing a luminance signal Y corresponding to the weighted sum of the three modulation signals R₀, G₀, B₀. A first derivator 19 (d/dT) receive luminance signal Y and provides a signal Y′ corresponding to the first derivative of signal Y. A second derivator 20 (d/dT) receives signal Y′ and provides a signal Y″ corresponding to the second derivative of signal Y. A voltage amplifier 21 (Aᵥ) receives signal Y″ and provides control signal S_{C} which thus corresponds to the amplified second derivative of luminance signal Y. Signal S_{C} then corresponds to a voltage which is applied across additional coil 17. Since additional coil 17 behaves as an integrator, the current flowing therethrough thus is proportional to signal Y′, that is, to the first derivative of luminance signal Y.

FIG. 2B shows another example of the forming of control and amplification circuit 16 in which second derivator 20 and voltage amplifier 21 of the example of embodiment illustrated in FIG. 2A are replaced with a transconductance amplifier 22 receiving signal Y′ and providing control signal S_{C}. Control signal S_{C} then corresponds to a current flowing through additional coil 17. Control signal SC thus is proportional to the derivative of luminance signal Y.

FIG. 3 illustrates the way in which a displayed image is modified when the correction circuit of FIG. 1 is used. Curve 23 shows an example of the time variation of luminance signal Y for the scanning of a line of display screen 15. Since luminance signal Y corresponds to a weighted sum of modulation signals R₀, G₀, B₀, it is representative of the light intensity emitted by the screen pixel exposed to the electron beams modulated based on modulation signals R₀, G₀, B₀. In the present example, luminance signal Y successively comprises a plateau 23A at the low level, a transition 23B between the low level and high level Y_{H}, a plateau 23C at high level Y_{H}, a transition 23D between high level Y_{H} and the low level, and finally a plateau 23E at the low level. On rising and falling transitions 23B and 23D, curve 23 representative of luminance signal Y generally substantially corresponds to a portion of a squared sine function.

Curve 24 shows the time variation of abscissa X_{corr} of the pixel exposed to the electron beams of the scanned line of screen 15. The origin of the abscissas for example corresponds to the pixel at the line beginning to the left of screen 15. The horizontal scan speed corresponds to the slope of curve 24. In the absence of a horizontal scan correction, the deviation of the electron beams is obtained only by the main horizontal deflection coil and is generally performed at constant speed or base speed.

When luminance signal Y is constant, that is, for low-level plateaus 23A, 23E and high-level plateau 23C, the first derivative of luminance signal Y is zero and the current flowing through the additional horizontal deflection coil is zero. The screen scanning then is obtained only by the main horizontal deflection coil, which corresponds to rectilinear portions 24A, 24C, 24E of curve 24. At the rising transition 23B of luminance signal Y, the first derivative of luminance signal Y varies and additional horizontal deflection coil 17 modifies the horizontal scan speed. Curve 24 thus comprises a portion 24B corresponding to a horizontal scan speed which decreases from a value greater than the base speed down to a speed smaller than the base speed. At the falling transition 23D of luminance signal Y, curve 24 comprises a portion 24D corresponding to a horizontal scan speed which increases from a value smaller than the base speed to a speed greater than the base speed.

Curve 26 shows the variation of luminance signal Y according to abscissa X_{corr}. Curve 26 is representative of the light intensity really sensed by a viewer watching the screen line scanned with a horizontal scanning corresponding to curve 24. At rising transition 23B, the viewer senses an area 26B where the luminance signal increases from the low level, first slowly, than rapidly, up to the high level. Similarly, at falling transition 23D, the viewer senses an area 26D where the luminance signal decreases from the high level, rapidly, then slowly, down to the low level. Transitions between low and high levels of the luminance signal are thus cleaner and the displayed image generally appears to be clearer.

However, calling W the scanned width of screen 15 for which luminance signal Y is greater than half the high level in the absence of a scan correction signal and W′ the width scanned with a scan correction, it can be noted that W′ is smaller than W. The viewer thus senses high light intensity areas which are reduced with respect to those which would be sensed in the absence of a horizontal scan correction. Generally, the dimensions of given portions of an image displayed according to the above correction method may appear to be modified to the eyes of a viewer. As an example, in the case where a tablecloth with black and white squares is displayed, the white squares appear with a width smaller than the black squares.

### SUMMARY OF THE INVENTION

The present invention aims at a correction of the horizontal screen scan speed which improves the clearness of the displayed image without deforming the displayed image.

To achieve this object, the present invention provides a method for correcting the line scan speed of a display screen according to the luminance of the pixels displayed on screen, wherein the line scan speed is modified by a correction means controlled from a control signal obtained from a time stretching of the product of the first and second derivatives of the luminance signal.

According to an object of the present invention, the screen is scanned by three electron beams, each electron beam being modulated from a modulation signal, the luminance signal being obtained from a weighted sum of the modulation signals.

According to an object of the present invention, the screen is scanned by at least one electron beam displaced by at least one deflection coil, the correction means comprising an additional deflection coil controlled by a current varying like the integral of the control signal.

According to an object of the present invention, the screen is scanned by at least one electron beam displaced by at least one deflection coil, the correction means comprising an additional deflection coil controlled by a current varying like the control signal.

According to an object of the present invention, the screen is scanned by at least one electron beam modulated from a modulation signal, an amplifier receiving the modulation signal and providing an amplified modulation signal to an electron gun generating the electron beam, the luminance signal used for the scan speed correction being obtained by filtering of the modulation signal by a filter having substantially the same passband as the amplifier.

According to an object of the present invention, the filter further imposes a delay to the luminance signal substantially equal to the delay provided by the amplifier.

According to an object of the present invention, the control signal is amplified by a gain which depends on the luminance signal.

According to an object of the present invention, the gain depends on the variation of the luminance signal on lines close to the scanned line.

According to an object of the present invention, the gain depends on the position of the electron beam with respect to the screen.

According to an object of the present invention, the control signal modifies the scan speed so that the scan speed is substantially zero upon variations of the luminance signal.

The present invention also provides a device for correcting the speed of line scanning of a display screen by at least one electron beam provided by an electron gun controlled from a modulation signal, comprising a control means receiving the modulation signal and providing a control signal to a means for correcting the line scan speed, the control signal being obtained from a time stretching of the product of the first and second derivatives of the luminance signal.

The foregoing object, features, and advantages of the present invention will be discussed in detail in the following non-limiting description of specific embodiments in connection with the accompanying drawings.

### BRIEF DESCRIPTION OF THE DRAWINGS

FIG. 1, previously described, schematically shows a conventional circuit for correcting the horizontal scan speed of a screen;

FIGS. 2A and 2B, previously described, show examples of embodiment of a portion of the correction circuit of FIG. 1;

FIG. 3 illustrates the correction performed on an example of an image to be displayed by a conventional correction circuit;

FIGS. 4A and 4B show two embodiments of a portion of the horizontal scan speed correction circuit according to the present invention;

FIG. 5 schematically illustrates the operation of the scan speed correction circuit according to the present invention;

FIG. 6 shows the correction brought to an example of an image to be displayed based on the correction method illustrated in FIG. 5; and

FIG. 7 schematically shows another embodiment of a portion of the correction circuit according to the present invention.

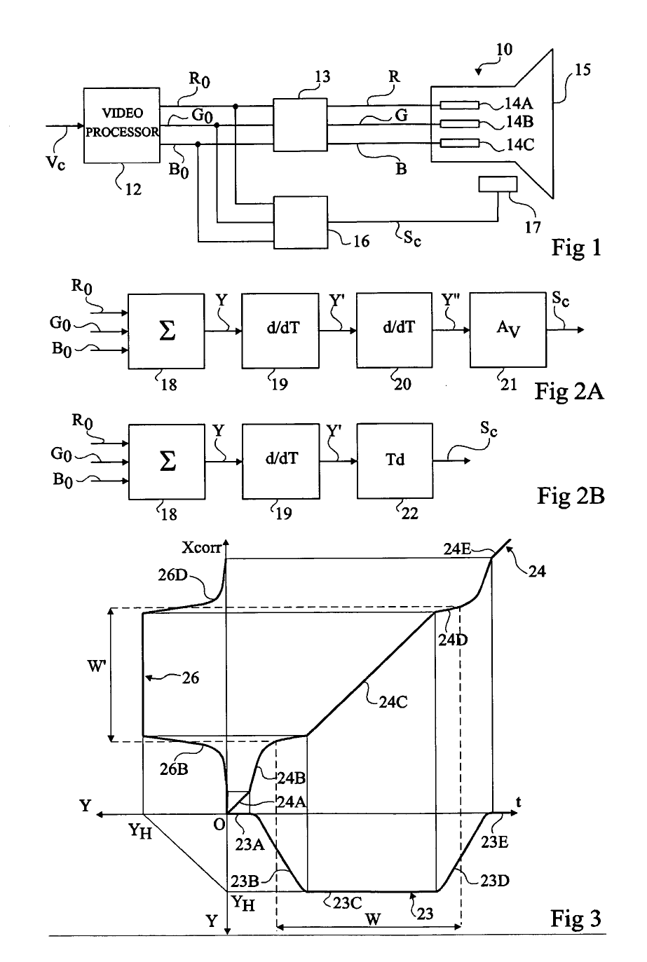

### DETAILED DESCRIPTION

The present invention consists of correcting the horizontal scan speed based on both the first derivative and the second derivative of the luminance signal. It is then especially possible to correct the horizontal scan speed to avoid modifying the position on screen of the pixel associated with the luminance value for which the first derivative of luminance signal Y is non-zero and the second derivative is zero, which point corresponds to the inflexion point and generally to the position of the pixel associated with a luminance value approximately equal to half the high level. Deformations of the displayed image are thus limited.

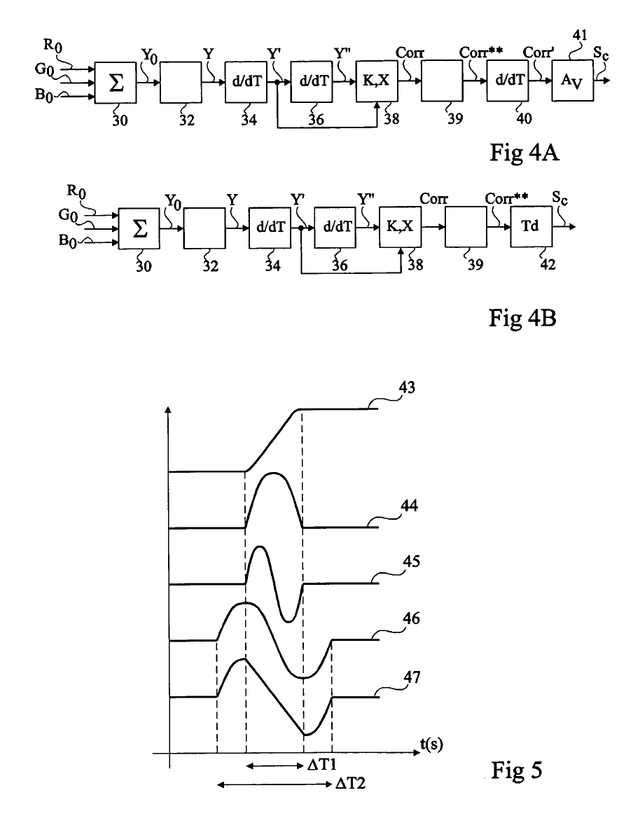

FIG. 4A shows a first embodiment according to the present invention of control circuit 16. Control circuit 16 comprises an adder 30 (Σ) receiving low-voltage modulation signals R₀, G₀, B₀ and providing a previous luminance signal Y₀ corresponding to a weighted sum of signals R₀, G₀, B₀. A filtering and delay circuit 32 receives primary luminance signal Y₀ and provides luminance signal Y. Filtering and delay circuit 32 behaves as a low-pass filter and brings a delay to primary luminance signal Y₀ to simulate the operating characteristics of power amplifier 13. A first derivator 34 (d/dT) receives luminance signal Y and provides a signal Y′ corresponding to the first derivative of luminance signal Y. A second derivator 36 (d/dT) receives signal Y′ and provides a signal Y″ corresponding to the second derivative of luminance signal Y. A multiplier 38 (K,X) receives first derivative signal Y′ and second derivative signal Y″ and provides a signal Corr corresponding to the product of first derivative signal Y′, of second derivative signal Y″, and of an amplification gain K. A treatment unit 39 receives signal Corr and provides a signal Corr** which corresponds to signal Corr “expanded” along to the time axis and modified. In the first embodiment, additional horizontal deflection coil 17 is controlled by a voltage applied thereacross. The control circuit then comprises a third derivator 40 (d/dT) receiving signal Corr** and providing a signal Corr′ to a voltage amplifier 41 (Aᵥ) which provides the control voltage S_{C} applied across coil 17.

FIG. 4B shows a second embodiment in which control and amplification circuit 16 comprises, instead of third derivator 40 and voltage amplifier 41 of the first embodiment, a transconductance amplifier 42 receiving correction signal Corr** and providing a control signal S_{C} corresponding to a current directly supplying additional horizontal deflection coil 17.

In the first and second embodiments, the current flowing through additional horizontal deflection coil 17 is obtained by an affine function of signal Corr**, that is, an function of the product of the first and second derivatives of luminance signal Y. Gain K is set according to the maximum value of the variation speed of luminance signal Y. The higher the maximum speed, the lower gain K. Control circuit 16 according to the present invention may be formed in digital or analog form. In particular, the control circuit may be completely integrated to video processing unit 12 and directly receive digital signals provided by video processor 12.

FIG. 5 shows curves 42, 44, 45, 46, and 47 illustrating the principle of the correction method according to the present invention. Curves 43, 44, and 45 respectively show the variation of luminance signal Y, of first derivative Y′ of the luminance signal, and of signal Corr upon transition of luminance signal Y between the low level and the high level.

According to the first and second embodiments of the correction method according to the present invention, a processing is performed on signal Corr to provide a signal Corr* shown by curve 46 which corresponds to signal Corr “expanded” along to the time axis.

As an example, the expansion factor may be substantially on the order of 2, that is, if ΔT1 corresponds to the duration of the transition of luminance signal Y, duration ΔT2 of variation of signal Corr* is equal to twice ΔT1. The synchronization of signal Corr* with respect to signal Corr can be obtained from the time when signal Y′ reaches a local maximum, which corresponds to the time when signal Corr becomes zero. It is thus sufficient to impose for the time at which signal Corr* becomes zero to correspond to the time when signal Y′ reaches a local maximum.

Curve 47 corresponds to signal Corr** obtained by an additional processing of signal Corr*. As an example, signal Corr** comprises a decreasing ramp substantially linear for duration ΔT1 and is identical to signal Corr* otherwise (possibly multiplied by an adapted amplification coefficient). The ramp is such that the sum of the magnetomotive force provided by additional deflection coil 17 and of the magnetomotive force provided by the main deflection coil (provided from an ascending linear ramp, as described previously) is constant at each time for duration ΔT1.

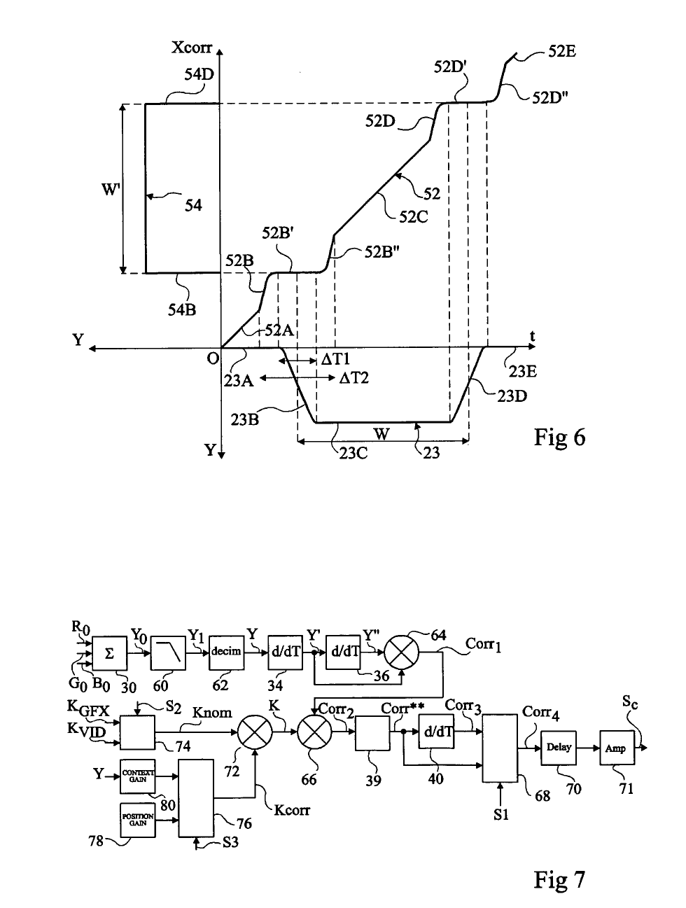

FIG. 6 shows curves similar to the curves shown in FIG. 3 obtained with a variation curve of luminance signal Y similar to curve 23 of FIG. 3 and for a correction performed with signal Corr**.

For low-level plateaus 23A, 23E and high-level plateau 23C, there is no contribution of additional horizontal deflection coil 17, except slightly before and little after a transition 23B, 23D between plateaus. Only the main horizontal deflection coil then contributes to the scan speed which, in the present example, is equal to a constant speed called the base speed. Curve 52 representative of corrected abscissa X_{corr} then corresponds to portions 52A, 52C, 52E of a linear ramp. During a variation of luminance signal Y and during a period preceding and a period following such a variation, signal Corr** varies and additional horizontal deflection coil 17 provides an additional magnetomotive force which algebraically adds to the magnetomotive force provided by the main horizontal deflection coil.

Signal Corr** is such that, for the duration (ΔT2−ΔT1)/2 preceding a transition 23B of luminance signal Y between the low level and the high level, the scan speed abruptly increases up to a speed greater than the base speed, then exhibits a deceleration phase 52B from the greater speed to a substantially zero speed. During transition 23B, the scan speed exhibits a phase 52B′ where it remains substantially zero. During time (ΔT2−ΔT1)/2 following transition 23B of luminance signal Y between the low level and the high level, the scan speed exhibits an acceleration phase 52B″ from the zero speed to a speed greater than the base speed. For a transition 23D between the high level and the low level of luminance signal Y, the scan speed exhibits successive phases 52D, 52D′, 52D″ of deceleration, maintaining at zero speed, and acceleration respectively similar to phases 52B, 52B′, 52B″.

Curve 54 shows the variation of luminance signal Y according to corrected abscissa X_{corr}. The electron beam scanning the screen is substantially motionless with respect to the screen during transitions 23B, 23D of luminance signal Y since corrected abscissa X_{corr} is constant. Curve 54 representative of luminance signal Y according to corrected abscissa X_{corr} thus exhibits a very abrupt rising edge 54B and falling edge 54D. Widths W and W′ are then substantially identical. The corrected image is sensed by a viewer with a better clearness without for the image dimensions to appear to be modified.

Signal Corr*, very close to signal Corr**, may be directly used instead of signal Corr**. An advantage is that signal Corr* is relatively simple to obtain from signal Corr. Corrected abscissa X_{corr} obtained by directly using signal Corr* is very close to curve 52. However, the rising and falling edges of the curve representative of luminance signal Y according to corrected abscissa X_{corr} are slightly less abrupt than edges 54B and 54D.

When signals Corr and Corr* are obtained by digital processing, an example of a method for obtaining digital data representative of signal Corr* consists of performing an oversampling of signal Corr (for example, by providing additional data by linear extrapolation of the digital data representative of signal Corr).

Of course, the present invention is likely to have various alterations, modifications, and improvements which will readily occur to those skilled in the art. In particular, in the third embodiment, derivators 34, 36, 40 may implement various algorithms to calculate the derivation, especially by using several values, successive or not, of the input signal.

FIG. 7 schematically shows a third embodiment of control circuit 16 according to the present invention adapted to digital signal processing. Elements common with the first or second embodiments bear the same reference numerals.

Adder 30 receives signals R₀, G₀, B₀ in digital form and provides primary digital luminance signal Y₀ to a low-pass digital filter 60 which simulates the passband of video amplifier 13. Digital filter 60 provides an intermediary luminance signal Y₁ to a decimator 62. Digital filter 60 for example is a digital filter with programmable coefficients, the coefficient programming being performed according to the nature of the video amplifier 13 used. Decimator 62 determines luminance signal Y by only choosing some of the digital values of intermediary luminance signal Y1 (for example, one digital value out of two, three out of five, etc.) provided by digital filter 60. First derivator 34 receives luminance signal Y and provides first derivative signal Y′ to second derivator 36. The decimation ratio is set especially according to the algorithm chosen for the derivation calculation by derivators 34, 36. First derivative digital signal Y′ and second derivative digital signal Y″ are multiplied by a first multiplier 64 to provide corrected signal Corr₁, which is multiplied by gain K by a second multiplier 66 to form signal Corr₂. The treatment unit 39 receives signal Corr₂ and provides signal Corr** as previously described. Third derivator 40 receives signal Corr₂ and provides a signal Corr₃. A multiplexer 68 receives signals Corr** and Corr₃. According to the value of a selection signal S1, multiplexer 68 provides a delay unit 70 with a signal Corr₄ equal to signal Corr₃ or to signal Corr**. Delay unit 70 supplies an amplifier 71 (Amp) which provides control signal S_{C}. Digital filter 60 and delay unit 70 behave as previously-mentioned filtering and delay circuit 32. When signal Corr₃ is selected by multiplexer 68, amplifier 71 corresponds to a voltage amplifier and the third embodiment is equivalent to the first embodiment. When signal Corr** is selected by multiplexer 68, amplifier 71 then is a transconductance amplifier and the third embodiment corresponds to the second embodiment.

Gain K is provided by a third multiplier 72 and corresponds to the product of a nominal gain Kₙₒₘ and of a corrective gain K_{corr}.

Nominal gain Kₙₒₘ is provided by a multiplexer 74 and corresponds, according to the value of a selection signal S2, to a first or a second gain value K_{VID} or K_{GFX}. First gain value K_{VID} is used when the image to be displayed corresponds to a conventional image extracted from the video signal received by the display terminal. Second gain value K_{GFX} is used when the image to be displayed corresponds to display elements which are added to the conventional image. These may for example be display elements generated directed by video processor 12 and corresponding to text displayed on screen upon setting operating parameters of the display terminal or information contained in the video signal, displayed after a voluntary action of the viewer (for example, information of “teletext” type).

Corrective gain K_{corr} is provided by a multiplexer 76 and, according to a selection signal S3, is equal to:
a first corrective gain value provided by a position gain unit 78 (POSITION GAIN) which depends on the position of the electron beam with respect to the screen;
a second corrective gain value provided by a contextual correction unit 80 (CONTEXT GAIN). The second corrective gain value varies according to the graphical elements to be displayed on screen. It may be, for example, a correction performed when the graphism to be displayed has a specific shape, for example, circular, for which it is preferable for transitions to be relatively smooth so that the contours of the displayed image do not appear as being too stepped to the viewer. For this purpose, gain context unit 80 can receive the digital values of luminance signal Y over several consecutive lines to be displayed to determine the second value of the correction gain; and
no correction, that is, a corrective gain equal to “1”.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method for correcting the line scan speed of a display screen according to a luminance of the pixels displayed on screen, wherein the line scan speed is modified by a correction means controlled from a control signal obtained from a time stretching of the product of the first and second derivatives of the luminance signal.

2. The correction method of claim 1, wherein the screen is scanned by three electron beams, each electron beam being modulated from a modulation signal the luminance signal being obtained from a weighted sum of the modulation signals.

3. The correction method of claim 1, wherein the screen is scanned by at least one electron beam displaced by at least one deflection coil, the correction means comprising an additional deflection coil controlled by a current varying as the integral of the control signal.

4. The correction method of claim 1, wherein the screen is scanned by at least one electron beam displaced by at least one deflection coil, the correction means comprising an additional deflection coil controlled by a current varying like as the control signal.

5. The correction method of claim 1, wherein the screen is scanned by at least one electron beam modulated from a modulation signal, an amplifier receiving the modulation signal and providing an amplified modulation signal to an electron gun generating the electron beam, the luminance signal used for the scan speed correction being obtained by filtering of the modulation signal by a filter having substantially the same passband as the amplifier.

6. The correction method of claim 5, wherein the filter further provides a delay to the luminance signal substantially equal to the delay provided by the amplifier.

7. The correction method of claim 1, wherein the control signal is amplified by a gain which depends on the luminance signal.

8. The correction method of claim 7, wherein the gain depends on the variation of the luminance signal on lines close to the scanned line.

9. The correction method of claim 7, wherein the gain depends on the position of the electron beam with respect to the screen.

10. The correction method of claim 1, wherein the control signal modifies the scan speed so that the scan speed is substantially zero upon variations of the luminance signal.

11. A device for correcting the speed of line scanning of a display screen by at least one electron beam provided by an electron gun controlled from a modulation signal, comprising a control means receiving the modulation signal and providing a control signal to a means for correcting the line scan speed, the control signal being obtained from a time stretching of the product of the first and second derivatives of the luminance signal.
